(19) United States
(12) Patent Application Publication
(10) Pub. No.: US 2008/0114516 A1
(43) Pub. Date: May 15, 2008

(54) Inflatable pusher

(76) Inventors: David M. Jackson, Clarkston, MI (US); Brian Timothy Seymour, Oakland Township, MI (US)

Correspondence Address: AUTOLIV ASP INC, 3350 AIRPORT ROAD, OGDEN, UT, 84405, US

(21) Appl. No.: 11/600,389

(22) Filed: Nov. 15, 2006

(51) Int. Cl. B60R 21/26; B60R 21/013

(52) U.S. Cl. 701/45; 280/736

(57) ABSTRACT

In one embodiment, an inflatable pusher includes a front panel and a rear panel connected to the front panel so as to define a chamber between the front and rear panels. An expandable section is coupled to the front and rear panels such that the expandable section comprises at least one fold configured to allow the front panel to extend away from the rear panel upon receipt of an inflation fluid within the chamber. The expandable section may be configured to be resettable such that the front panel can be reapproximated with the rear panel for redeployment.

### TECHNICAL FIELD

The present disclosure relates generally to the field of automotive protective airbags and devices. More specifically, the present disclosure relates to an inflatable pusher.

### BRIEF DESCRIPTION OF THE DRAWINGS

Understanding that the drawings depict only typical embodiments and are not therefore to be considered limiting, the embodiments will be described and explained with additional specificity and detail through the use of the accompanying drawings, in which like components are designated by like numerals throughout.

FIG. 1 is an exploded view of a vehicle door including an inflatable pusher.

FIG. 2 is a plan view of an uninflated inflatable pusher.

FIG. 2A is a perspective view of the inflatable pusher of FIG. 2.

FIG. 2B is a perspective view of the inflatable pusher of FIG. 2 showing an inflation fluid beginning to extend a front panel of the inflatable pusher.

FIG. 3A is a cross-sectional view of one embodiment of an inflatable pusher installed as part of the trim panel of an interior of a vehicle.

FIG. 3B shows the inflatable pusher of FIG. 5A displayed in a deployed position.

FIG. 4A shows another embodiment of an inflatable pusher, wherein the inflator is replaceably attached to an interior of a vehicle, and a compressor is provided to suck the gas out of the inflatable pusher to facilitate resetting it after deployment.

FIG. 4B shows the inflatable pusher of FIG. 6A deployed in a pre-crash position.

FIG. 4C shows the inflatable pusher of FIG. 6B after decompression or ventilation of the partially deployed inflatable pusher back into a packed state.

### DETAILED DESCRIPTION OF EXEMPLARY EMBODIMENTS

The present disclosure relates to auxiliary protective airbags for providing strategically localized protection in the case of a crash. For instance, pelvic airbag assemblies have been developed to protect occupants of a vehicle from side impact and rollover crashes. Likewise, knee airbag assemblies have been developed to protect front seat occupants from front impact crashes, where the vehicle may crush the lower legs and/or knees of an occupant.

An inflatable pusher is disclosed that may be part of the trim panel of the interior of a vehicle and therefore need not rip through the trim panel to deploy. The inflatable pusher may be made as a blow-molded part, such as with a grained class A surface, which may be formed to be integrated in appearance and contour with the vehicle's interior trim panel. Alternatively, other modes of manufacture may be used, such as gas-assisted injection molding or through assembly of the various sub-parts of the inflatable pusher after manufacture of the same. In some embodiments, the pusher may be retractable such that it is configured to be resettable after deployment for later redeployment or reuse. Ways to accomplish resettability will be discussed later.

By incorporating a class A part as an inflatable pusher, the pusher may more easily be packaged and incorporated within different vehicles than, for instance, expandable metal technology. Likewise, hybrid blow-molding technology may be used that may include both plastic and metal in the same process. Although this disclosure may refer primarily to an inflatable pusher in a vehicle door, it is to be understood that such a pusher may be incorporated into any part of the vehicle to protect various parts of the body of an occupant in the event of a crash.

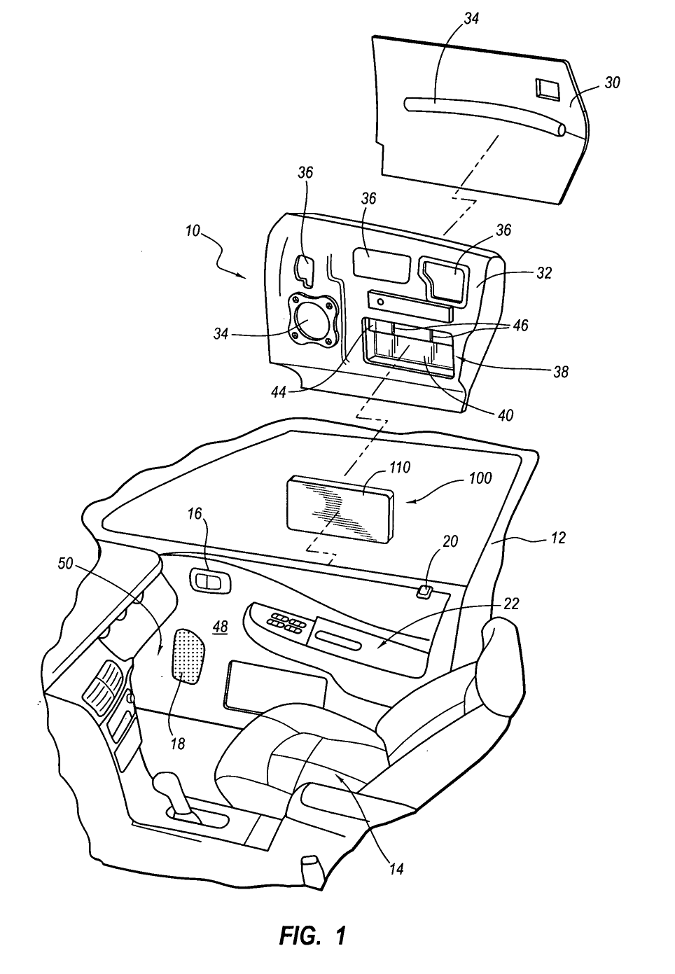

With reference to the accompanying drawings, FIG. 1 is an exploded view of a vehicle door 10, which is a front passenger-side door that is positioned forward of the vehicle's B pillar 12. Alternatively, the vehicle door 10 may also represent all types of vehicle doors generally, including both front drivers-side doors and passenger compartment doors. The vehicle door 10 is positioned proximate to an occupant seat 14 and may include a door latch 16, an audio speaker 18, a lock switch 20, and an armrest 22.

The vehicle door 10 comprises an outer skin 30 and an inner skin 32. The inner skin 32 is positioned inside of the outer skin 30. The outer skin 30 and the inner skin 32 may be constructed of steel or other types of metal and are attached to the vehicle body (not shown). A stiffening bar 34 designed to render support and/or structural integrity to the vehicle door 10 during a crash or accident may also be added to the door 10 between the outer skin 30 and the inner skin 32.

The inner skin 32 may further include one or more openings 36. The openings 36 are positioned on the interior side of the inner skin 32 and are designed to facilitate the addition of the door latch 16, the audio speaker 18, the lock switch 20, and other such components, to the vehicle door 10. More specifically, the openings 36 are designed such that the door latch 16, the audio speaker 18, and/or the lock switch 20 may fit into the openings 36. The inner skin 32 may additionally define a recess 38 for reception of an inflatable, retractable pusher 100. The recess 38 may include a back stop 40 and a connecting bar 44 having connecting apertures 46.

The vehicle door 10 may further comprise a trim panel 48. The trim panel 48 may be a layer of vinyl, plastic, leather, or other similar materials that is positioned on the interior of the vehicle door 10 in order to improve the visual appearance of the door 10. The trim panel 48 may be attached to the inner skin 32 such that the trim panel 48 covers the inner skin 32 and the outer skin 30.

The inflatable pusher 100 may also be attached to the vehicle door 10. The inflatable pusher 100 may be manufactured to any desired size that fits with the construction of the overall vehicle door 10. In alternative embodiments, the inflatable pusher 100 may be sized and positioned to come in contact with an occupant's arm, shoulder, legs, knees, head, etc., by positioning the inflatable pusher 100 within the vehicle's interior and proximate where those body parts would reside for an average vehicle occupant.

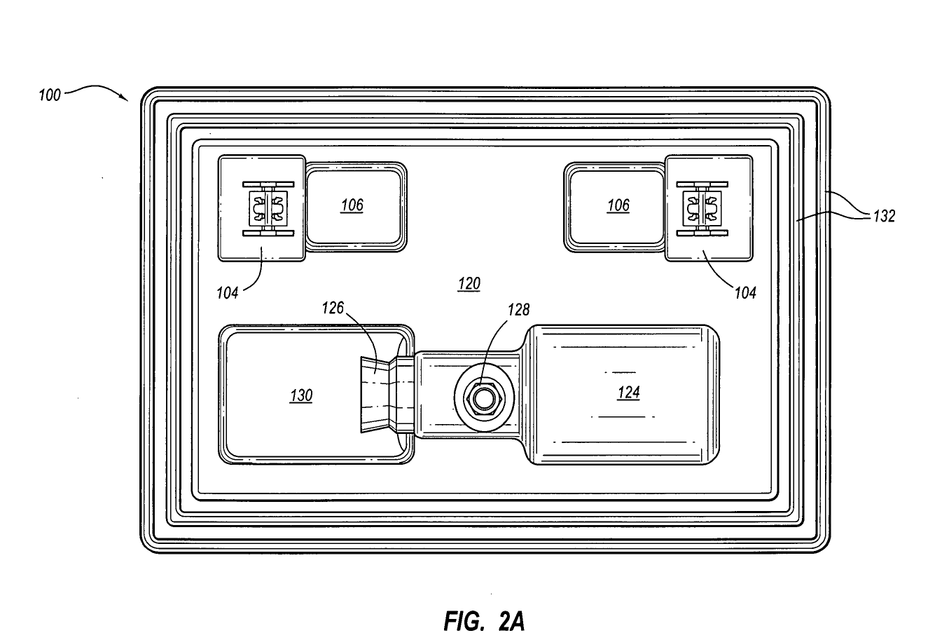

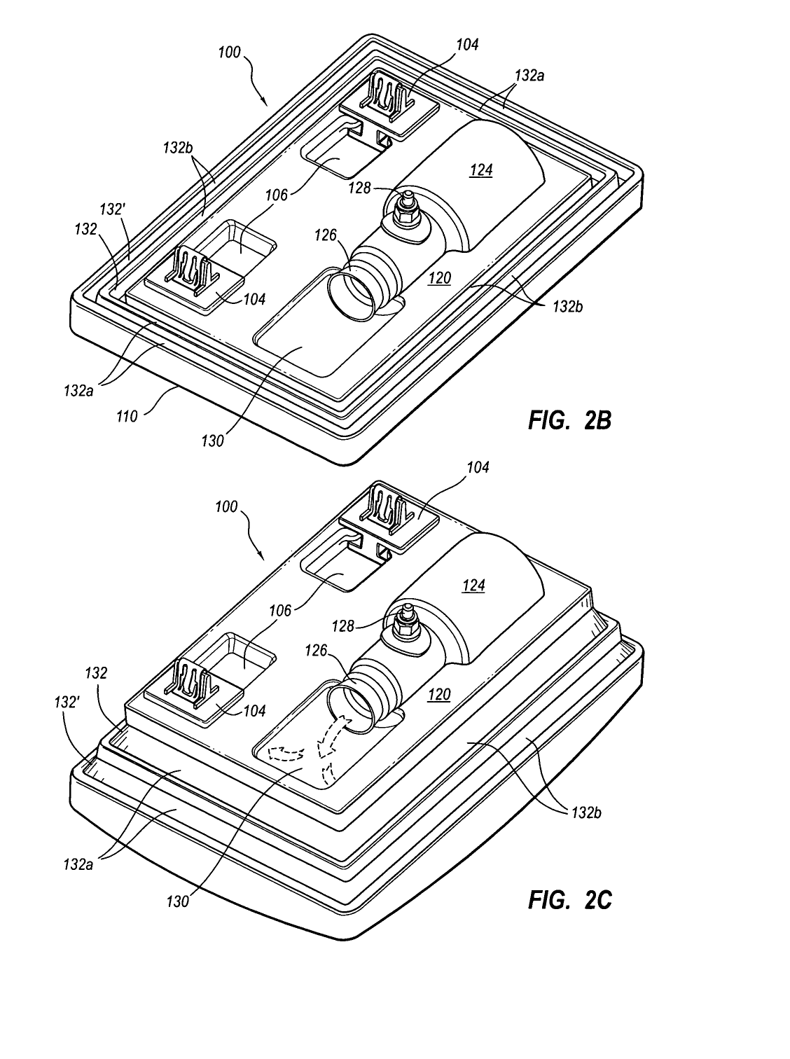

The inflatable pusher 100 displayed in FIG. 1 may be retained in the vehicle door 10 by connection devices, such as with connectors 104 (shown in FIGS. 2A, 2B, and 2C), which may be inserted into connecting apertures 46 of the connecting bar 44. One skilled in the art may conceive of various other ways to secure inflatable pusher 100 within the door 10 or other part of the vehicle while remaining within the scope and spirit of this disclosure. In some embodiments, the inflatable pusher 100 may be secured within the door 10 (or other part of the vehicle's interior) such that a front panel 110 of the inflatable pusher 100 substantially matches up with, and is inserted within, the trim panel 48 in both contour and appearance. As will be explained, the front panel 110 may be expandable upon deployment of the inflatable pusher 100, such that the front panel 110 extends beyond the trim panel 48 and into the vehicle's interior.

In order to facilitate the retention of the inflatable pusher 100 within the inner skin 32, the recess 38 may be formed to accommodate the inflatable pusher 100. The size of the recess 38 may correspond to the size of the inflatable pusher 100 to provide enough space within the recess 38 for the inflatable pusher 100.

The terms “substantially” as used herein may be applied to modify any quantitative representation which could permissibly vary without resulting in a change in the basic function to which it is related. For example, the front panel 110 of the inflatable pusher 100 as disclosed herein may be flush with the trim panel 48, or may be partially offset from the trim panel 48, in either the direction of the vehicle's interior or in the direction of the vehicle's skin 30, 32.

Referring to FIG. 2A, an inflatable pusher 100 is shown in an uninflated configuration. FIG. 2B is a perspective view of the inflatable pusher of FIG. 2A. The inflatable pusher 100 is optionally manufactured such that, when in the uninflated configuration, the inflatable pusher 100 is substantially rectangular or substantially trapezoidal in shape. However, other embodiments are possible in which the inflatable pusher 100 has a square, round, triangular, pentagonal, hexagonal, polygonal, quadrilateral, or other desired shape. As mentioned, in some embodiments, the inflatable pusher 100 may be manufactured by a blow-molding process, in which the material or materials are poured into a pre-prepared mold to form an integral, single piece. The front panel 110 may include similar color and/or shading as the trim panel 48 of the vehicle in which it is mounted (or inserted).

The inflatable pusher 100 may include a rear panel 120, to which the connectors 104 are attached. The rear panel 120 may further define longitudinal apertures 106, along which connectors 104 are slidably positioned so that the connectors 104 are easily lined up and connected into connecting the apertures 46. Other ways of mounting inflatable pusher 100 into the door 10 may be apparent to skilled persons.

The rear panel 120 may further include an inflator 124 for providing an inflation fluid, such as a gas or liquid, to expand the front panel 110. Commonly, inflators include a pyrotechnic, which, when activated, rapidly injects the fluid into a target airbag or inflatable device. Inflator 124, however, may be integrally-molded within the inflatable pusher 100 when it is blow-molded or otherwise manufactured. In the alternative, the inflator 124 may be located separately within the recess 38, and securely positioned so as to provide substantially the same function. The inflator 124 may include a cylindrical mouth 126, which may be formed so as to increase the speed of exit of the inflation fluid, and which also may direct, in part, the direction of exit flow of the inflation fluid. Additionally, the inflator 124 may include an inflation connector 128 configured to receive a supply of the inflation fluid.

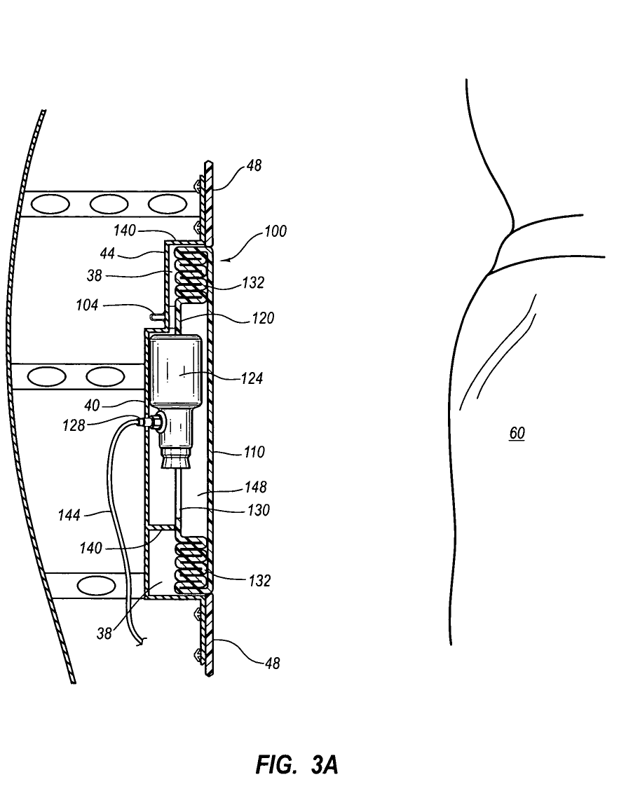

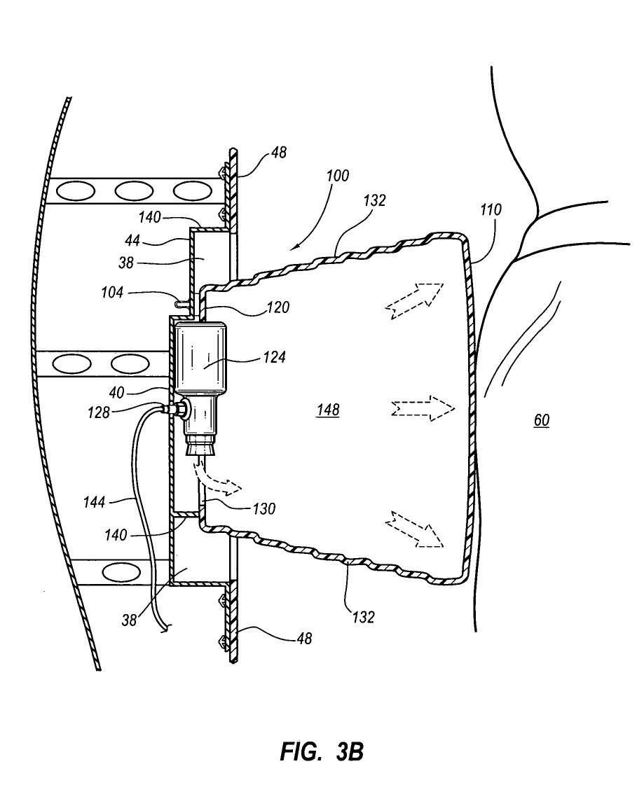

The rear panel 120 may further define an inflation inlet 130, through which the inflation fluid may pass to inflate a chamber (148 in FIGS. 3A and 3B) defined between the rear panel 120 and the front panel 110, thereby expanding the front panel 110 beyond the trim panel 48.

Referring now to FIG. 2C, the inflatable pusher 100 is shown in perspective view during the process of expansion, wherein the front panel 110 extends away from the rear panel 120. For such expansion, the inflatable pusher 100 may include at least one reversible expansion fold 132 that unfolds outwardly, causing the front panel 110 to extend beyond the trim panel 48, such as shown in FIG. 3B. The folds 132 may be manufactured to be accordion-like, and, in some embodiments, may be reversed after deployment to re-stow the front panel 110 in the recess 38 of the inner skin 32, so as to be reapproximated with the rear panel 120 and prepared for redeployment.

As is also evident, reversible folds 132 connect the rear panel 120 to the front panel 100 of the inflatable pusher 100. Therefore, the inflatable pusher 100 may be integrally molded in a single manufacturing process, such as through blow-molding or through gas-assisted injection molding. In an uninflated configuration (e.g., FIG. 2B), the rear panel 120 may reside (or be incorporated) within a first expansion fold 132, while the first expansion fold 132 may reside within another, second expansion fold 132′, which in turn resides within the front panel 110. This pattern of mutual insertion allows the pusher 100 to contain numerous folds and remain sufficiently thin for mounting within the door 10.

The reversible folds 132 likewise allow inflatable pushers 100 of differing expanded widths to be manufactured for differently sized vehicles and for pushers 100 located in different locations. The more folds 132 used, the greater the possible extension of the inflatable pusher 100 in an inflated configuration. For instance, a large truck may require greater numbers of expansion folds 132 to adequately reach and push against a vehicle occupant than would be required in a compact car, based on differing distances between the vehicle occupant and the trim panel 48.

In addition, in embodiments in which the pusher is formed of a rectangle, square, or other basic geometric shape, the folds 132 may be present in pairs 132a, 132b, with matching folds being present on opposite parallel sides of the inflatable pusher 100. Each member of these paired folds 132a, 132b may be substantially equivalent in size and orientation to the other member in the pair. Thus, the expandable front panel 110 may deploy substantially perpendicularly from its original placement in a vehicle. In some applications, it may be desirable to cause the front panel 110 to deploy at an angle to its original placement, e.g. at an angle from the trim panel 48 of a vehicle. This may be done by providing asymmetrical pairs of folds 132a, 132b to permit one side of the front panel 10 to expand further than another side.

The reversible folds 132 may be tuned in size, number, and shape to control the distance the front panel 110 travels when deployed. Specifically, the number or size of pairs of folds 132a, 132b may be increased to increase the deployment distance of the front panel 110 from the rear panel 120. Additionally, the expansion folds 132 may be adjusted in orientation and/or shape to control the deployed position of the front panel 110 relative to the trim panel 48, and relative to its originally-mounted position.

The material used to construct the inflatable pusher 100 may include metal, plastic, or combinations thereof, regardless of whether the pusher is blow-molded. The rear panel 120, for example, may be formed of metal, while the folds 132 and front panel 110 may be formed of plastic. In the alternative, the entire inflatable pusher 100 may be formed of plastic. Where plastic is used, the plastic may comprise a thermoplastic elastomer (TPE) material, a thermoplastic olefin (TPO) material, or a combination thereof as are known for use in airbags. However, further embodiments may also be made using one or more other types of materials, plastic or otherwise.

Referring to FIG. 3A, displayed is a cross-sectional view of one embodiment of an inflatable pusher 100 installed as part or a subset of the trim panel 48 of an interior of a vehicle. As shown, the front panel 110 of the inflatable pusher 100 is substantially fit with the contour of the trim panel 48. The accordion-like expansion folds 132 fit inside of the recess 38, with the connectors 104 being secured through the connecting apertures 46 (not shown) of the connecting bar 44. The inflator 124 is likewise provided sufficient room inside of the recess 38 to fit without forcing the front panel 110 to extend past the trim panel 48 in an uninflated configuration.

Note also that the inflator 124 may abut the back stop 40. By providing a back stop 40, and by otherwise lining the recess 38 with sidewalls 140, the inflation fluid injected from the inflator 124 may be locally contained and forced through the inflation inlet 130. Back stop 40 and sidewalls 140 may, therefore, contribute to the quickness and/or direction of the deployment of the inflatable pusher 100, and/or lessen the force required by the pyrotechnic (or other device) of the inflator 124 to achieve the desired rate of inflation. Nevertheless, back stop 40 and sidewalls 140 are not required, and the constrained space between the outer skin 30 and the inner skin 32 of the door 10 may be sufficient to locally contain the inflation fluid in some embodiments.

The inflation fluid may pass through a tube 144 that connects directly to the inflator connector 128, which receives the inflation fluid for injection into the inflatable pusher 100. The inflation fluid may be injected by the inflator 124 into a chamber 148, which is defined between the front panel 110 and the rear panel 120. As the chamber 148 fills up with the inflation fluid, the front panel 110 is pushed progressively outward toward a vehicle occupant 150.

FIG. 3B displays the result of deployment, after which the inflatable pusher 100 is in an inflated configuration with the front panel 110 having been pushed against the vehicle occupant 150. Inflation occurs after the inflator 124 injects an inflation fluid, which may be supplied by the tube 144, through the inflation inlet 130, and into the chamber 148. The process may generally work rapidly to deploy the inflatable pusher 100 within sufficient time in the event of a crash or accident. The plurality of expansion folds 132 are shown inflated to a fully extended position beyond the trim panel 48. Note, however, that depending on the size of the occupant 150, some of the expansion folds 132 may remain uninflated following some deployments because the front panel 100 will have impacted the occupant 150. If the occupant 150 shifts during a crash in such a deployment, however, the inflator 124 may continue to force the inflation fluid into the chamber 148, and thereby cause the front panel 110 to continue extending toward the shifting occupant 150.

As mentioned, the folds 132 in some embodiments may be reversible, so that the inflatable pusher 100 may be reset after deployment. The reversible folds 132 may be pushed back into the recess 38 where the folds 132 will remain reapproximated until the next deployment event. The retractable nature of the reversible folds 132 may arise in part from the material used. For example, TPO and TPE materials both provide a degree of flexibility to facilitate resetting the inflatable pusher after deployment. A skilled person will appreciate that there are other materials that may function similarly, and therefore may be used in making the reversible folds 132. Minor cosmetic adjustments may be made upon resetting the inflatable pusher 100, but the inflatable pusher 100, in some embodiments, need not be replaced unless damaged in an accident or crash.

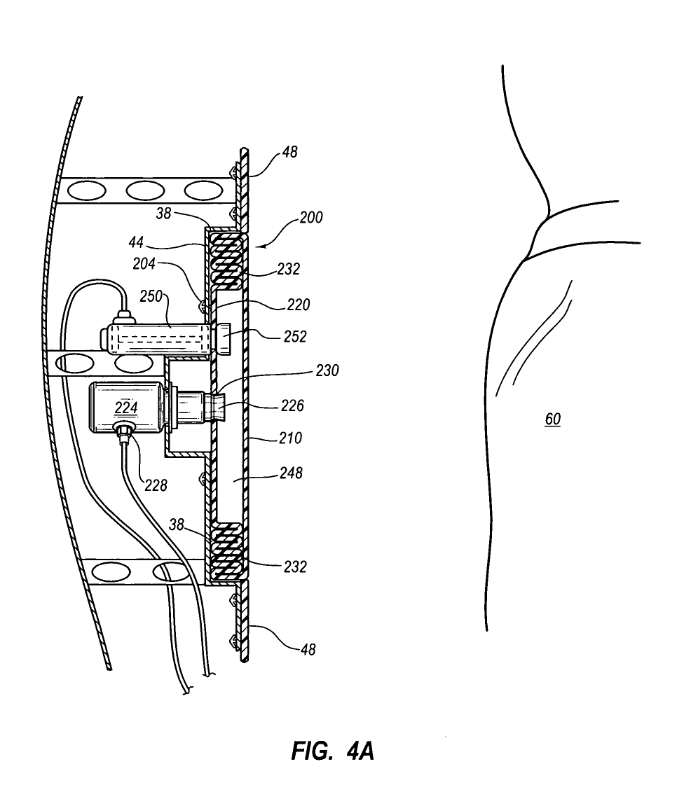

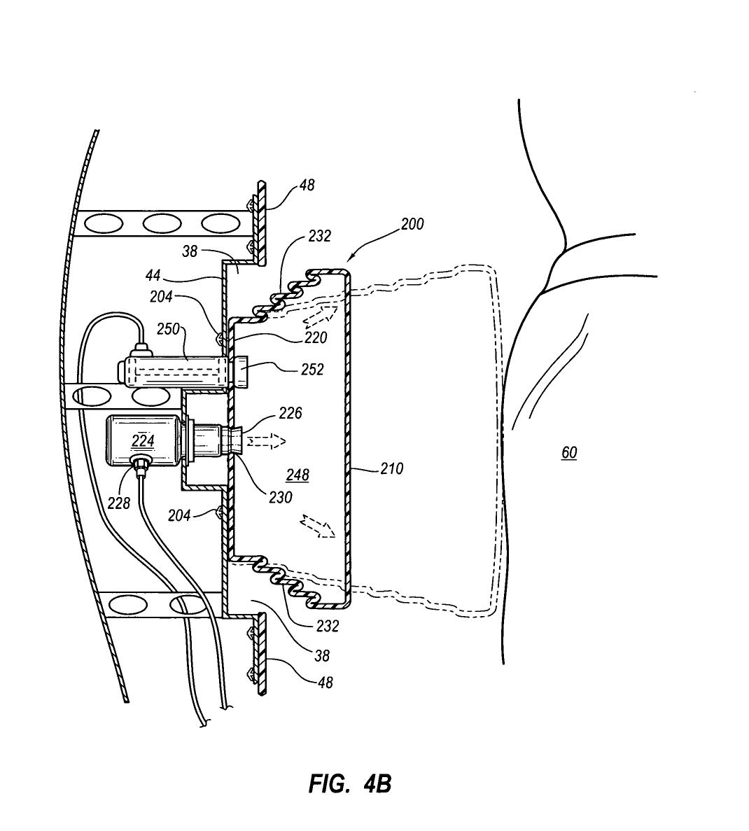

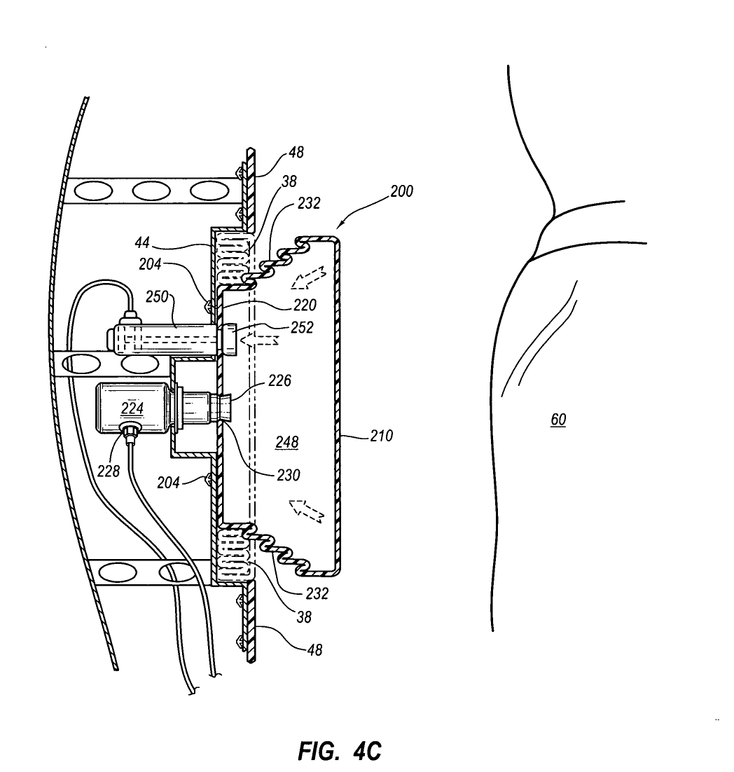

FIG. 4A shows another embodiment of an inflatable pusher 200, which also may be retained within and act as a part of a trim panel 48 of a vehicle, such as in a vehicle door 10. For instance, connectors 204 may be inserted into connecting apertures 46 of the connecting bar 44. Like inflatable pusher 100, when the inflatable pusher 200 is secured within a recess 38 or other aperture, a front panel 210 of the inflatable pusher 200 substantially matches up with, and is inserted within, the trim panel 48 in both contour and appearance. Skilled persons may conceive of alternate, yet equally viable, ways to retain the inflatable pusher within the trim panel 48. The inflatable pusher 200 includes a rear panel 220 to which the connectors 204 are attached and that may be integrally-molded with the front panel 210.

The inflatable pusher 200 further includes an inflator 224 that is attached to an interior of a vehicle, for instance to the recess 38, to another portion of a skin 30 or 32, or to another support structure of the vehicle door 10. The main reason to have the inflator 224 approximated to the inflatable pusher 200 without it being integrally molded thereto is so that the inflator 224 may be replaced. For instance, many inflators 224 include a pyrotechnic feature to create a rapid injection of gas that needs replacement after being expended. There also may be other reasons that the inflator 224 should be individually replaceable, such as if it is damaged.

The inflator 224, therefore, contains an inflation fluid, such as a gas or liquid, to expand the front panel 110. The inflator 224 may include a cylindrical mouth 226, which may be formed so as to increase the speed of exit flow of the inflation fluid. The inflator 224 may also be the type that is not replaced, e.g. integrally molded within the inflatable pusher 200, and include an inflation connector 228 for receipt of the inflation fluid from a refillable supply (not shown).

The rear panel 220 may further define an inflation inlet 230 through which the inflation fluid may pass to partially unfold at least one reversible expansion fold 232 that connects the front panel 210 to the rear panel 220, and makes the inflatable pusher 200 expandable. By injecting an inflation fluid through inflation inlet 230 into a chamber 248 defined between the front and rear panels 210, 220, the front panel 210 is expanded beyond the trim panel 48 of a vehicle. The cylindrical mouth 226 may pass through the inflation inlet 230 to substantially form a seal between the cylindrical mouth 226 and the rear panel 220, for reasons that will shortly become apparent.

As discussed with respect to inflatable pusher 100, the inflatable pusher 200 may be reset after deployment. In one embodiment, this is accomplished by prestressing a plastic (such as TPO, TPE, or combinations thereof) of which the inflatable pusher 200 is formed while the inflatable pusher 200 is in an uninflated configuration. As the inflation fluid used during deployment is ventilated out of the chamber, the prestressed expandable folds 232 are forced to refold, causing the front panel 210 to be reapproximated with the rear panel 220 for redeployment.

In the alternative, the inflatable pusher 200 may further comprise an optional compressor 250 to suck the inflation fluid out of the pusher to facilitate resetting the pusher after deployment. The compressor 250 is connected through the rear panel 220 so that it forms a seal, e.g., with a mouth 252 of the compressor 250 located within the chamber, thereby creating a desired vacuum suction to forcibly deflate the inflatable pusher, causing the front panel 210 to be reapproximated with the rear panel 220 in a stored, uninflated configuration. There is often at least one compressor (not shown) in conventional vehicles to level the vehicle suspension, and such a compressor may be operatively to the chamber 248 shown to provide the desired suction.

FIG. 4B shows the inflatable pusher of FIG. 4A deployed in a pre-crash position, and in a fully deployed position as shown in phantom. FIG. 4C shows the inflatable pusher of FIG. 4B after decompression or ventilation of the inflatable pusher 200 as it is decompressing to be backed into a stored, uninflated configuration. FIG. 4C also shows the inflatable pusher 200 in its final uninflated configuration as shown in phantom.

Use of the compressor 250 or a prestressed inflatable pusher 200 allows the inflatable pusher 200 to undergo a pre-crash deployment, such as shown in the partially-deployed front panel 210 in FIG. 4B, and still be easily reset while the vehicle is in motion. To execute a pre-crash deployment, the inflator 224 may be electrically connected to a sensor (not shown), such as an accelerometer of the vehicle, that senses a deceleration beyond a threshold rate (indicating a possible impending crash). Upon sensing such a deceleration signal (or other signal such as object recognition via sensors on a vehicle bumper), the inflator 224 is triggered to begin inflating the inflatable pusher 200.

By causing the inflatable pusher 200 to be partially deployed upon sensing an imminent crash, an occupant 150 of the vehicle may be pushed into a favorable position for impact, and the partially-filled inflatable pusher 200 can be completely filled by the inflator 224 more quickly if a crash does occur. If no crash occurs, the compressor 250 sucks the inflation fluid out of the inflatable pusher 200, or the prestressed inflatable pusher ventilates the inflation fluid, thereby causing the front panel 210 to return to its stored location as shown in phantom in FIG. 4C. Additionally, even if no pre-crash signal is available, and a crash does occur that causes the inflatable pusher 200 to fully expand (shown in phantom in FIG. 4B), the inflatable pusher 200 may be reset for redeployment by suction or ventilation (or other ways as conceived by skilled persons).

The inflatable pusher 100 or 200 includes a front panel 110, 210 and a rear panel 120, 220. An inflator such as inflator 124 or inflator 224 is an example of a means for directing an inflation fluid in between the front and rear panels. The inflator 124, 224 may have a cylindrical mouth 126, 226 to further guide the direction of injection of the inflation fluid. The rear panel 120, 220 may further define an inflation inlet 130, 230 through which the fluid may enter from the inflator 124, 224.

The reversible expansion fold 132, 232 is an example of a means for extending the front panel away from the rear panel upon receipt of the fluid between the front and rear panels. In some embodiments, the expansion fold 132, 232 may be multiplied according to distance required for deployment, and may be reversible so that the front panel may be reapproximated with the rear panel for redeployment. A connector such as connector 104 or connector 204, in combination with the longitudinal aperture 106, comprise one example of means for incorporating the front panel as part of an interior trim of a vehicle. The connectors 104, 204 and the longitudinal aperture 106 may also facilitate securing the inflatable pusher into the inner skin of a vehicle.

Without further elaboration, it is believed that one skilled in the art can use the preceding description to utilize the invention to its fullest extent. The examples and embodiments disclosed herein are to be construed as merely illustrative and not a limitation of the scope of the present invention in any way. It will be apparent to those having skill in the art that changes may be made to the details of the above-described embodiments without departing from the underlying principles of the invention. In other words, various modifications and improvements of the embodiments specifically disclosed in the description above are within the scope of the appended claims. The scope of the invention is therefore defined by the following claims. Note also that elements recited in means-plus-function format are intended to be construed in accordance with 35 U.S.C. §112 ¶6.

What is claimed is:

1. An inflatable pusher comprising:
a front panel;
a rear panel connected to the front panel so as to define a chamber between the front and rear panels; and
an expandable section coupled to the front and rear panels, wherein the expandable section comprises at least one fold configured to allow the front panel to extend away from the rear panel upon receipt of an inflation fluid within the chamber, and wherein the expandable section is configured to be resettable such that the front panel can be reapproximated with the rear panel for redeployment.

2. The inflatable pusher of claim 1, wherein the front panel comprises a plastic.

3. The inflatable pusher of claim 2, wherein the plastic comprises at least one of a thermoplastic elastomer (TPE), a thermoplastic olefin (TPO), and combinations thereof.

4. The inflatable pusher of claim 1, further comprising an inflator positioned to inflate the chamber.

5. The inflatable pusher of claim 4, wherein the inflator is integrated within the rear panel.

6. The inflatable pusher of claim 4, wherein the inflator is sealably connected to the rear panel.

7. The inflatable pusher of claim 6, further comprising:
a compressor sealably connected to the rear panel to suck the inflation fluid out of the chamber after at least a partial deployment of the front panel, thus resetting the expandable section.

8. The inflatable pusher of claim 6, further comprising:
a sensor electrically connected to the inflator that provides a signal indication of an impeding accident to the inflator.

9. The inflatable pusher of claim 1, wherein the front panel and the expandable section are integrally molded.

10. The inflatable pusher of claim 9, wherein the front panel, the rear panel, and the expandable section are integrally molded.

11. The inflatable pusher of claim 7, wherein the integrally molded front panel, rear panel, and expandable section comprises a plastic that is prestressed and is stored in an uninflated configuration.

12. The inflatable pusher of claim 9, wherein the rear panel comprises a metal, and wherein the expandable section and the front panel comprise at least one of a thermoplastic elastomer (TPE), a thermoplastic olefin (TPO), and combinations thereof.

13. The inflatable pusher of claim 1, wherein the expandable section comprises a plurality of folds.

14. The inflatable pusher of claim 1, wherein the expandable section is configured to allow the front panel to deploy to a predetermined position relative to the rear panel.

15. An inflatable pusher comprising:
a front panel configured to be incorporated into a trim panel of a vehicle's interior;
a rear panel connected to the front panel so as to define a chamber therebetween; and
a plurality of reversible folds connecting the front and rear panels to facilitate the extension of the front panel beyond the trim panel upon receipt of an inflation fluid within the chamber, wherein the front panel and the plurality of reversible folds are integrally molded.

16. The inflatable pusher of claim 15, wherein the rear panel further comprises at least one connector configured to secure the pusher within an inner skin of the vehicle.

17. The inflatable pusher of claim 15, wherein the plurality of reversible folds are configured to be resettable such that the front panel can be reapproximated with the rear panel for redeployment.

18. The inflatable pusher of claim 17, wherein the front panel, the rear panel, and the plurality of reversible folds are integrally molded.

19. The inflatable pusher of claim 18, wherein the integrally molded front panel, rear panel, and plurality of reversible folds form a single piece comprising a plastic, wherein the single plastic piece has been prestressed and is stored in an uninflated configuration.

20. The inflatable pusher of claim 17, further comprising:
an inflator sealably connected to the rear panel to inflate the chamber.

21. The inflatable pusher of claim 20, further comprising:
a sensor electrically connected to the inflator that provides a signal indication of an impeding accident to the inflator.

22. The inflatable pusher of claim 20, further comprising:
a compressor sealably connected to the rear panel to suck the inflation fluid out of the chamber after at least a partial deployment of the front panel, thus resetting the plurality of reversible folds.

23. The inflatable pusher of claim 15, wherein the inflation fluid comprises a gas.

24. The inflatable pusher of claim 15, wherein the rear panel and the plurality of reversible folds comprise at least one of a thermoplastic elastomer (TPE), a thermoplastic olefin (TPO), and combinations thereof.

25. The inflatable pusher of claim 15, wherein the plurality of reversible folds are configured to allow the front panel to deploy to a predetermined position relative to the rear panel.

26. An inflatable pusher comprising:
a front panel;
a rear panel connected to the front panel so as to define a chamber therebetween, the rear panel defining an inflation inlet leading into the chamber, the rear panel configured for attachment within a vehicle door such that the front panel comprises a subset of a trim panel of the vehicle door;
an inflator positioned to inject an inflation fluid into the inflation inlet; and
an expandable section integrally connecting the front and rear panels, the expandable section configured to allow the front panel to be deployed beyond the trim panel of the door upon receipt of the inflation fluid within the chamber.

27. The inflatable pusher of claim 26, wherein the expandable section is configured to be resettable such that the front panel can be reapproximated with the rear panel for redeployment.

28. The inflatable pusher of claim 26, wherein the front panel, the rear panel, and the expandable section are integrally molded as a single plastic piece, wherein the single plastic piece is prestressed and is stored in an uninflated configuration.

29. The inflatable pusher of claim 27, wherein the inflator is sealably connected to the rear panel through the inflation inlet.

30. The inflatable pusher of claim 29, further comprising:
a sensor electrically connected to the inflator that provides a signal indication of an impeding accident to the inflator, upon which the chamber is partially filled, thereby partially deploying the front panel.

31. The inflatable pusher of claim 30, further comprising:
a compressor sealably connected to the rear panel to suck the inflation fluid out of the chamber after at least the partial deployment of the front panel, thus resetting the expandable section.

32. The inflatable pusher of claim 31, wherein the compressor deflates the inflatable pusher to reset the expandable section back in an uninflated configuration after the occurrence of an accident.

33. The inflatable pusher of claim 26, wherein the front panel, the rear panel, and the expandable section are integrally molded.

34. The inflatable pusher of claim 33, wherein the inflatable pusher comprises at least one of a thermoplastic elastomer (TPE), a thermoplastic olefin (TPO), and combinations thereof.

35. The inflatable pusher of claim 26, wherein the expandable section is configured to allow the front panel to deploy to a predetermined position relative to the rear panel.

36. An inflatable pusher comprising:
a retractable front panel configured to be incorporated into a trim panel of a vehicle door;
a rear panel coupled to the front panel so as to define a chamber therebetween, the rear panel configured for attachment to the vehicle door to hold the front panel in place;
an expandable section integrally connecting the front and rear panels, wherein the expandable section comprises a plurality of folds configured to allow the front panel to extend away from the rear panel upon receipt of an inflation fluid within the chamber;
an inflator sealably connected to the rear panel to inject the inflation fluid into the chamber to cause expanding deployment of the front panel, wherein the expandable section is configured to be resettable such that the front panel can be reapproximated with the rear panel for redeployment;
a sensor electrically connected to the inflator that provides a signal indication of an impeding accident to the inflator, upon which the chamber is partially filled; and
a compressor sealably connected to the rear panel to suck the inflation fluid out of the chamber after at least the partial deployment of the front panel, thus resetting the expandable section.

37. An inflatable pusher comprising:
a front panel;
a rear panel;
means for directing a fluid in between the front and rear panels;
means for extending the front panel away from the rear panel upon receipt of the fluid between the front and rear panels, wherein the extending means is reversible such that the front panel can be reapproximated with the rear panel for redeployment; and
means for incorporating the front panel as part of an interior trim of a vehicle.
